(19) United States
(12) Patent Application Publication
(10) Pub. No.: US 2012/0206432 A1
(43) Pub. Date: Aug. 16, 2012

(54) INVERTER AND ORGANIC LIGHT EMITTING DISPLAY USING THE SAME

(76) Inventors: Chul-Kyu Kang, Yongin-city (KR); Dae-Hyun Noh, Yongin-city (KR)

(21) Appl. No.: 13/244,420

(22) Filed: Sep. 24, 2011

(30) Foreign Application Priority Data
Feb. 10, 2011 (KR) 10-2011-0011956

(51) Int. Cl. G09G 3/32; G09G 5/00; H02M 7/537

(52) U.S. Cl. 345/212; 363/131; 345/76

(57) ABSTRACT

An inverter is capable of improving the reliability of driving. The inverter includes a first transistor coupled between a first power source and an output terminal of the inverter and having a gate electrode coupled to a first input terminal of the inverter, a second transistor coupled between a second power source and the output terminal, and having a gate electrode coupled to a second input terminal of the inverter, a first capacitor coupled between the gate electrode of the first transistor and the first input terminal, a second capacitor coupled between the gate electrode of the second transistor and the second input terminal, a third transistor coupled between the gate electrode of the first transistor and a reset power source, and a fourth transistor coupled between the gate electrode of the second transistor and the reset power source.

### CROSS-REFERENCE TO RELATED APPLICATION

This application claims priority to and the benefit of Korean Patent Application No. 10-2011-0011956, filed on Feb. 10, 2011, in the Korean Intellectual Property Office, the entire content of which is incorporated herein by reference.

### BACKGROUND

1. Field

Aspects of embodiments according to the present invention relate to an inverter and an organic light emitting display using the same.

2. Description of Related Art

Recently, various types of flat panel displays (FPD) with reduced weight and volume in comparison to cathode ray tube (CRT) have been developed. The types of FPD include a liquid crystal display (LCD), a field emission display (FED), a plasma display panel (PDP), and an organic light emitting display.

Among the types of FPD, the organic light emitting display displays an image using organic light emitting diodes (OLED) that generate light by re-combination of electrons and holes. The organic light emitting display has high response speed and is driven with low power consumption. A typical organic light emitting display supplies current corresponding to data signals to the OLEDs by using transistors formed in pixels so that light is emitted by the OLEDs.

The typical organic light emitting display includes a data driver for supplying the data signals to data lines, a scan driver for sequentially supplying scan signals to scan lines, and a pixel unit including a plurality of pixels coupled to the scan lines and the data lines.

The pixels included in the pixel unit are selected when the scan signals are supplied to the scan lines in order to receive the data signals from the data lines. The pixels that receive the data signals generate light components with brightness (e.g., predetermined brightness) corresponding to the data signals, and display an image (e.g., a predetermined image).

On the other hand, the scan driver includes stages coupled to the scan lines. Each of the stages includes a plurality of transistors in order to supply the scan signals to the scan lines. P-type (for example, PMOS) or N-type (for example, NMOS) transistors that constitute the stages are formed (e.g., simultaneously formed) in a panel together with the pixels. When the stages are formed in the panel together with the pixels, manufacturing cost is reduced.

However, when the stage is realized by the N-type transistor, the turn-off of the transistor is not controlled by the Vth shift of the transistor so that an erroneous operation may occur. That is, in the case of the N-type transistor, Vth is negative shifted to correspond to time so that the transistor is not turned off in a state where a voltage Vgs between a gate and a source is 0V (that is, Vgs=0V).

### SUMMARY

Accordingly, embodiments of the present invention are directed toward an inverter capable of improving the reliability of driving and an organic light emitting display using the same.

According to an embodiment of the present invention, an inverter includes a first transistor coupled between a first power source and an output terminal of the inverter and including a gate electrode coupled to a first input terminal of the inverter, a second transistor coupled between a second power source and the output terminal, and including a gate electrode coupled to a second input terminal of the inverter, a first capacitor coupled between the gate electrode of the first transistor and the first input terminal, a second capacitor coupled between the gate electrode of the second transistor and the second input terminal, a third transistor coupled between the gate electrode of the first transistor and a reset power source, and a fourth transistor coupled between the gate electrode of the second transistor and the reset power source.

The third transistor and the fourth transistor may be configured to be turned on when a reset signal is supplied to gate electrodes of the third transistor and the fourth transistor. The inverter may be configured to allow the reset signal to be supplied at least once before the inverter is normally driven in a normal driving period. The first power source and the second power source may be configured to alternately and respectively supply voltages to the first input terminal and the second input terminal in the normal driving period. The first power source may be configured to output a voltage higher than that of the second power source. The reset power source may be configured to output a voltage lower than that of the second power source. The second power source may be configured to supply a voltage to the first input terminal and the second input terminal when the reset signal is supplied. The first to fourth transistors may include NMOS transistors.

An organic light emitting display according to a first embodiment of the present invention includes a scan driver including stages coupled to scan lines, the scan driver being configured to supply scan signals to the scan lines, a data driver for supplying data signals to data lines, and pixels positioned at crossing regions of the scan lines and the data lines. Each stage of the stages includes the inverter as claimed in any one of claims 1 to 8.

An organic light emitting display according to a second embodiment of the present invention includes a scan driver including stages coupled to scan lines, the scan driver being configured to supply scan signals to the scan lines, a data driver for supplying data signals to data lines, and pixels positioned at crossing regions of the scan lines and the data lines. A stage of the stages includes a first transistor coupled between a first input terminal of the stage and an output terminal of the stage, and having a gate electrode coupled to a first node; a first capacitor coupled between the gate electrode of the first transistor and the first node; a second transistor coupled between the output terminal and a second power source, and having a gate electrode coupled to a second node; a second capacitor coupled between the gate electrode of the second transistor and the second node; a third transistor coupled between the first node and the second power source, the third transistor being configured to be turned on when a reset signal is supplied to a gate electrode of the third transistor; a fourth transistor coupled between the second node and the second power source, the fourth transistor being configured to be turned on when the reset signal is supplied to a gate electrode of the fourth transistor; and a fifth transistor coupled between a reset power source and the gate electrodes of the first and second transistors, the fifth transistor being configured to be turned on when the reset signal is supplied to a gate electrode of the fifth transistor.

The organic light emitting display may further include a sixth transistor coupled between a first power source and the second node, and having a gate electrode coupled to a second input terminal of the stage, a seventh transistor coupled between the first node and the second power source, and having a gate electrode coupled to the second node, an eighth transistor coupled between the first node and a third input terminal of the stage, and having a gate electrode coupled to a fourth input terminal, and a ninth transistor coupled between the second node and the second power source, and having a gate electrode coupled to the third input terminal.

The organic light emitting display may further include a third capacitor coupled between the gate electrode of the sixth transistor and the second input terminal, a fourth capacitor coupled between the gate electrode of the seventh transistor and the second node, a fifth capacitor coupled between the gate electrode of the eighth transistor and the fourth input terminal, a sixth capacitor coupled between the gate electrode of the ninth transistor and the third input terminal, and a tenth transistor coupled between the reset power source and the gate electrodes of the sixth, seventh, eighth, and ninth transistors, the tenth transistor being configured to be turned on when the reset signal is supplied to a gate electrode of the tenth transistor.

In the inverter according to embodiments of the present invention and the organic light emitting display using the same, a capacitor is coupled to the gate electrode of each of the transistors and a voltage charged in the capacitor negatively biases the transistors so that the transistors may be stably turned off.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a circuit diagram illustrating an inverter according to an embodiment of the present invention;

FIG. 2 is a waveform chart illustrating an embodiment of a method of driving the inverter of FIG. 1;

FIG. 3 is a graph illustrating the voltage change characteristic of an N-type transistor;

FIG. 4 is a block diagram illustrating an organic light emitting display according to an embodiment of the present invention;

FIG. 5 is a circuit diagram illustrating a stage circuit according to an embodiment of the present invention; and

FIG. 6 is a waveform chart illustrating an embodiment of a method of driving the stage of FIG. 5.

### DETAILED DESCRIPTION OF THE EMBODIMENTS

Hereinafter, certain exemplary embodiments according to the present invention will be described with reference to the accompanying drawings. Here, when a first element is described as being coupled to a second element, the first element may be directly coupled to the second element, or it may be indirectly coupled to the second element via one or more third elements. Further, some of the elements that are not essential to the complete understanding of the invention may be omitted for clarity. Also, like reference numerals refer to like elements throughout.

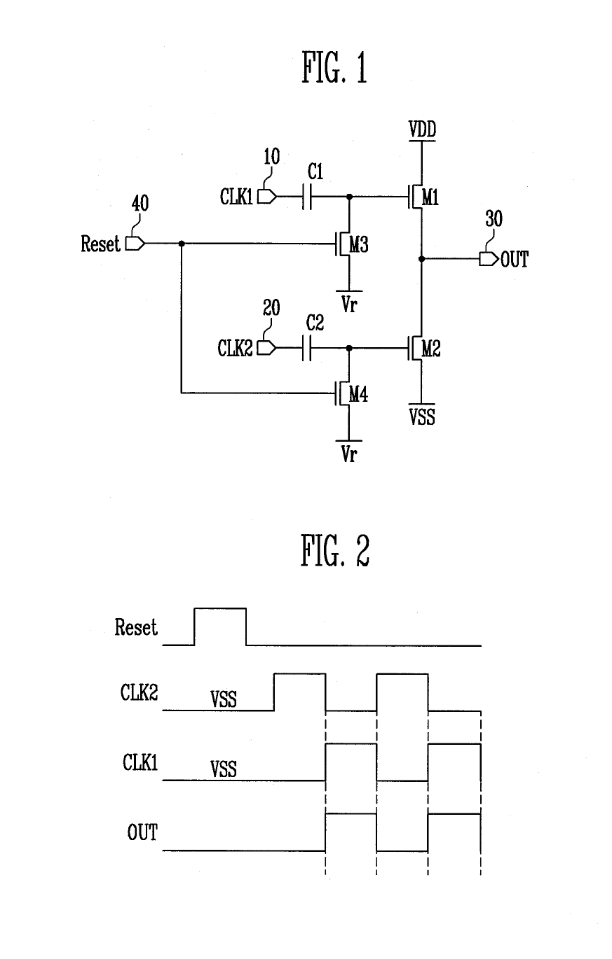

Hereinafter, exemplary embodiments by which those skilled in the art may perform the present invention will be described in detail with reference to FIGS. 1 to 6.

FIG. 1 is a circuit diagram illustrating an inverter according to an embodiment of the present invention.

Referring to FIG. 1, the inverter, according to the embodiment of the present invention, includes a first transistor M1 and a second transistor M2 serially coupled between a first power source VDD and a second power source VSS, a first capacitor C1 coupled between the gate electrode of the first transistor M1 and a first input terminal 10, a third transistor M3 coupled between the gate electrode of the first transistor M1 and a reset power source Vr, a second capacitor C2 coupled between the gate electrode of the second transistor M2 and a second input terminal 20, and a fourth transistor M4 coupled between the gate electrode of the second transistor M2 and the reset power source Vr.

A first electrode of the first transistor M1 is coupled to the first power source VDD, and a second electrode of the first transistor M1 is coupled to an output terminal 30. Then, the gate electrode of the first transistor M1 is coupled to a first terminal of the first capacitor C1. The first transistor M1 controls coupling between the first power source VDD and the output terminal 30 in accordance with the voltage applied to the gate electrode of the first transistor M1.

A first electrode of the second transistor M2 is coupled to the output terminal 30, and a second electrode of the second transistor M2 is coupled to the second power source VSS. Then, the gate electrode of the second transistor M2 is coupled to a first terminal of the second capacitor C2. The second transistor M2 controls coupling between the second power source VSS and the output terminal 30 in accordance with the voltage applied to the gate electrode of the second transistor M2.

Here, since high and low voltages are alternately supplied to the first input terminal 10 and the second input terminal 20, the first transistor M1 and the second transistor M2 are alternately turned on and off to supply the voltage of the first power source VDD or the second power source VSS to the output terminal 30. Here, the first power source VDD is set to have a higher voltage than the second power source VSS.

The first capacitor C1 is coupled between the first input terminal 10 and the gate electrode of the first transistor M1. The first capacitor C1 controls the voltage of the gate electrode of the first transistor M1 to correspond to the voltage supplied to the first input terminal 10.

The second capacitor C2 is coupled between the second input terminal 20 and the gate electrode of the second transistor M2. The second capacitor C2 controls the voltage of the gate electrode of the second transistor M2 to correspond to the voltage supplied to the second input terminal 20.

A first electrode of the third transistor M3 is coupled to the first terminal of the first capacitor C1, and a second electrode of the third transistor M3 is coupled to the reset power source Vr. The gate electrode of the third transistor M3 is coupled to the third input terminal 40. The third transistor M3 is turned on when a reset signal (Reset) is supplied to the third input terminal 40.

A first electrode of the fourth transistor M4 is coupled to the first terminal of the second capacitor C2, and a second electrode of the fourth transistor M4 is coupled to the reset power source Vr. Then, the gate electrode of the fourth transistor M4 is coupled to the third input terminal 40. The fourth transistor M4 is turned on when the reset signal (Reset) is supplied to the third input terminal 40.

On the other hand, according to an embodiment of the present invention, the transistors M1 to M4 included in the inverter are formed of NMOS transistors. The voltage of the reset power source Vr is set as a lower voltage than the voltages supplied to the second terminals of the first capacitor C1 and the second capacitor C2 so that the NMOS transistors M1 and M2 may be stably turned off. For example, if the output of the second power source VSS is supplied to the first and second input terminals 10 and 20 when the reset signal (Reset) is supplied, the reset power source Vr is set as a lower voltage than that of the second power source VSS. The reset power source Vr is set to output a voltage by which the transistors M1 and M2 may be stably turned off, considering the characteristics of the transistors.

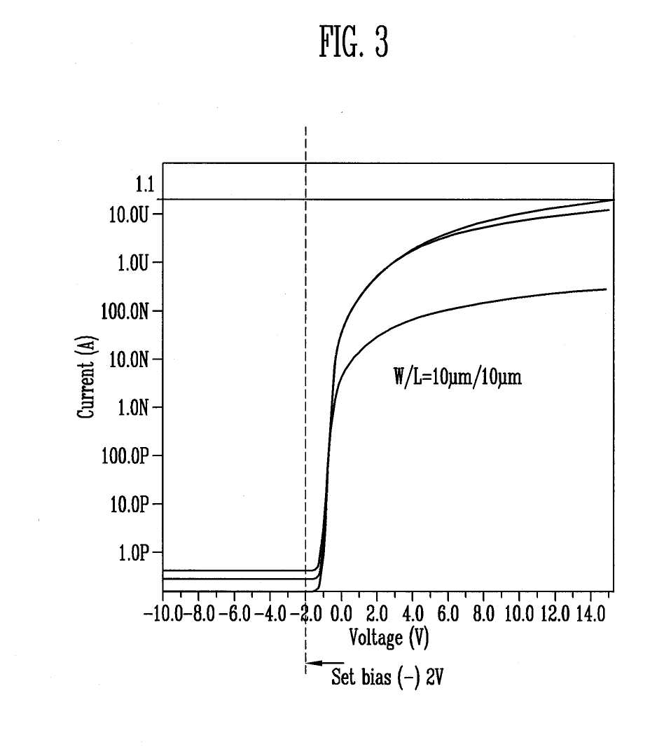

FIG. 2 is a waveform chart illustrating an embodiment of a method of driving the inverter of FIG. 1.

Referring to FIG. 2, the reset signal (Reset) is supplied to the third input terminal 40 before the inverter is normally driven. Clock signals CLK1 and CLK2 are not supplied to the first input terminal 10 and the second input terminal 20. In this case, the output of the second power source VSS is supplied to the first input terminal 10 and the second input terminal 20 as a low voltage.

When the reset signal (Reset), e.g., a high-level voltage, is supplied, the third transistor M3 and the fourth transistor M4 are turned on. When the third transistor M3 and the fourth transistor M4 are turned on, the output of the reset power source Vr is supplied to the gate electrodes of the first transistor M1 and the second transistor M2.

In this case, each of the first capacitor C1 and the second capacitor C2 is charged with the voltage corresponding to a voltage difference between the second power source VSS and the reset power source Vr. Here, since the reset power source Vr is set to output a lower voltage than the second power source VSS, the voltages of the gate electrodes of the first transistor M1 and the second transistor M2 are set to be lower than the voltages of the first input terminal 10 and the second input terminal 20. For example, it is assumed that the voltage corresponding to −2V is charged to each of the first capacitor C1 and the second capacitor C2.

Then, in the normal driving period of the inverter, voltages of different polarities are supplied to the first input terminal 10 and the second input terminal 20, respectively. For example, the first clock signal CLK1 (for example, the voltage of VDD) is supplied to the first input terminal 10 and the second clock signal CLK2 having an opposite phase to the phase of the first clock signal CLK1 is supplied to the second input terminal 20.

When the second clock signal CLK2 (e.g., the voltage of VDD) is supplied to the second input terminal 20, the voltage of the gate electrode of the second transistor M2 increases by the coupling of the second capacitor C2. At this time, the second transistor M2 is turned on so that the voltage of the second power source VSS is supplied to the output terminal 30.

Then, when the first clock signal CLK1 is supplied to the first input terminal 10, the voltage of the gate electrode of the first transistor M1 increases by the coupling of the first capacitor C1. At this time, the first transistor M1 is turned on so that the voltage of the first power source VDD is supplied to the output terminal 30.

That is, the first transistor M1 and the second transistor M2 selectively and respectively supply the voltage of the first power source VDD or the second power source VSS to the output terminal 30 to correspond to the first clock signal CLK1 and the second clock signal CLK2. Here, the first transistor M1 and the second transistor M2 may be stably turned off by the voltage charged in the first capacitor C1 and the second capacitor C2.

In more detail, the voltage-current characteristic of an exemplary N-type transistor is illustrated in FIG. 3. According to the voltage-current characteristic as illustrated in FIG. 3, when the voltage of 0V (for example, VSS) is applied to the gate electrodes of the first transistor M1 and the second transistor M2, the first transistor M1 and the second transistor M2 are not turned off. However, according to the embodiment of the present invention, the voltages of the gate electrodes of the first transistor M1 and the second transistor M2 are additionally reduced by −2V by using the voltages charged in the first capacitor C1 and the second capacitor C2 so that the first transistor M1 and the second transistor M2 may be stably turned off.

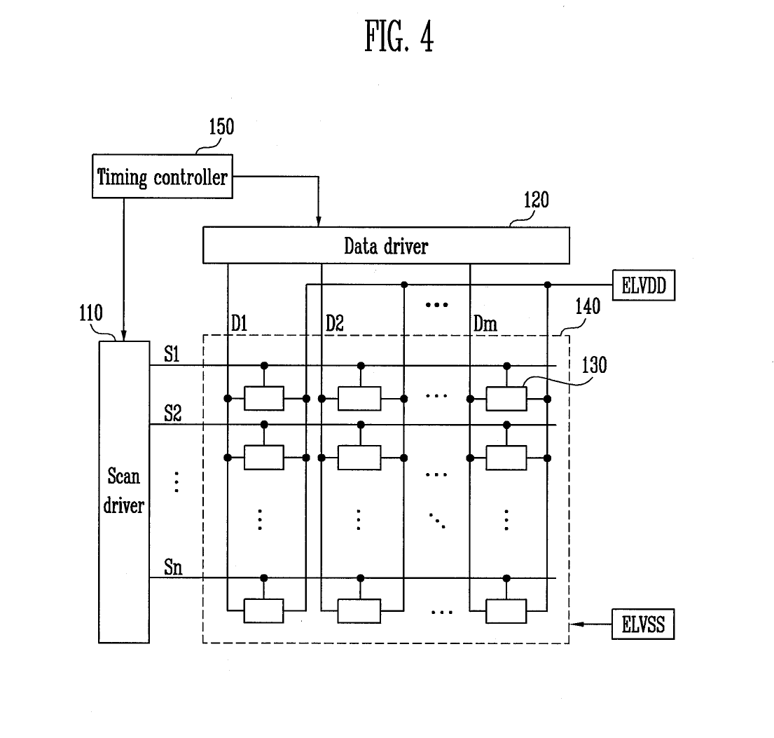

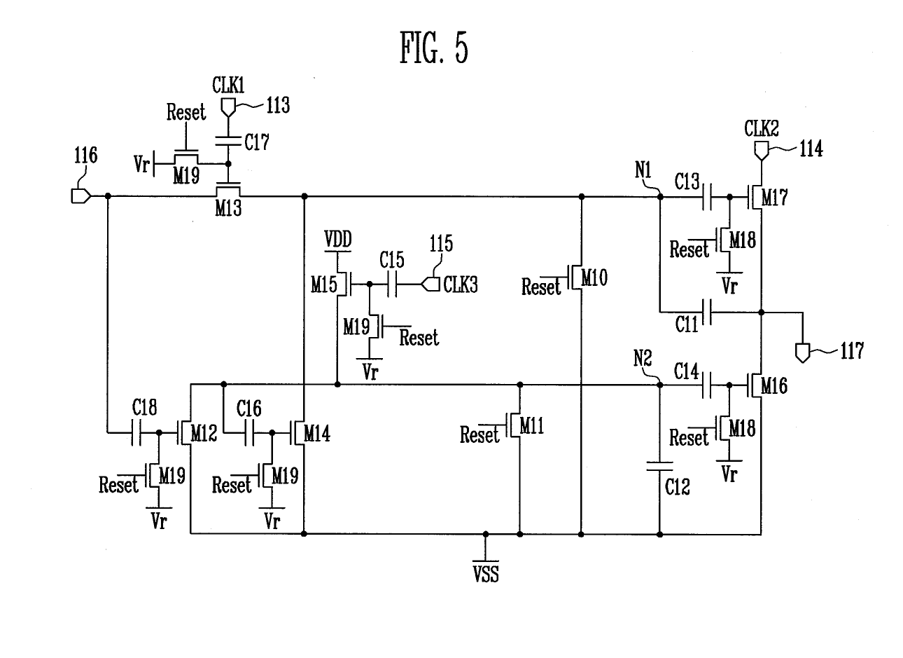

FIG. 4 is a block diagram illustrating an organic light emitting display according to an embodiment of the present invention.

Referring to FIG. 4, the organic light emitting display according to the embodiment of the present invention includes a pixel unit 140 having pixels 130 positioned at the crossing regions of scan lines S1 to Sn and data lines D1 to Dm, a scan driver 110 for driving the scan lines S1 to Sn, a data driver 120 for driving the data lines D1 to Dm, and a timing controller 150 for controlling the scan driver 110 and the data driver 120.

The timing controller 150 controls the scan driver 110 and the data driver 120.

The data driver 120 supplies data signals to the data lines D1 to Dm in synchronization with scan signals. The data signals supplied to the data lines D1 to Dm are supplied to the pixels 130 selected by the scan signals.

The scan driver 110 sequentially supplies the scan signals to the scan lines S1 to Sn. When the scan signals are supplied to the scan lines S1 to Sn, the pixels 130 are selected in units of horizontal lines (e.g., line by line). The scan driver 110 includes stages respectively coupled to the scan lines S1 to Sn and the stages include the inverter circuit illustrated in FIG. 1.

The pixels 130 receive the data signals and supply the currents corresponding to the received data signals to organic light emitting diodes to generate light with set or predetermined brightness.

FIG. 5 is a circuit diagram illustrating a stage circuit according to an embodiment of the present invention. In FIG. 5, the transistors included in a stage are N-type transistors (for example, NMOS transistors).

Referring to FIG. 5, the stage, according to the embodiment of the present invention, includes 10^{th} to 19^{th} transistors, M10 to M19, and 11^{th} to 18^{th} capacitors C11 to C18.

A first electrode of the tenth transistor M10 is coupled to a first node N1, and a second electrode of the tenth transistor M10 is coupled to the second power source VSS. The gate electrode of the tenth transistor M10 receives a reset signal (Reset). The tenth transistor M10 is turned on when the reset signal (Reset) is supplied in order to supply the output of the second power source VSS to the first node N1.

Here, the reset signal (Reset) is supplied at the beginning of one frame so that the tenth transistor M10 is turned on at the beginning of one frame. When the output of the second power source VSS is supplied to the first node N1, the 13^{th} capacitor C13 is charged with the voltage corresponding to a difference between the reset power source Vr and the second power source VSS. Therefore, the 13^{th} capacitor C13 is coupled between the first node N1 and the gate electrode of the 17^{th} transistor M17.

A first electrode of the 11^{th} transistor M11 is coupled to a second node N2, and a second electrode of the 11^{th} transistor M11 is coupled to the second power source VSS. Then, the gate electrode of the 11^{th} transistor M11 receives the reset signal (Reset). The 11^{th} transistor M11 is turned on when the reset signal (Reset) is supplied in order to supply the output of the second power source VSS to the second node N2.

Here, the reset signal (Reset) is supplied at the beginning of one frame so that the 11^{th} transistor M11 is turned on at the beginning of one frame. When the output of the second power source VSS is supplied to the second node N2, the 14^{th} capacitor C14 is charged with the voltage corresponding to the difference between the reset power source Vr and the second power source VSS. Therefore, the 14^{th} capacitor C14 is coupled between the second node N2 and the gate electrode of the 16^{th} transistor M16.

The 12^{th} transistor M12 is coupled between the second node N2 and the second power source VSS. Then, the gate electrode of the 12^{th} transistor M12 is coupled to a fourth input terminal 116 via the 18^{th} capacitor C18. Therefore, the 18^{th} capacitor C18 is coupled between the fourth input terminal 116 and the gate electrode of the 12^{th} transistor M12. The 12^{th} transistor M12 is turned on or off in accordance with the voltage supplied to the fourth input terminal 116. Here, the fourth input terminal receives the sampling signal or the start signal of a previous stage.

The 13^{th} transistor M13 is coupled between the fourth input terminal 116 and the first node N1. Then, the gate electrode of the 13^{th} transistor M13 is coupled to a first input terminal 113 via the 17^{th} capacitor C17. Therefore, the 17^{th} capacitor C17 is coupled between the gate electrode of the 13^{th} transistor M13 and the first input terminal 113. The 13^{th} transistor M13 is turned on or off in accordance with the voltage supplied to the first input terminal 113. The first input terminal 113 receives the first clock signal CLK1.

The 14^{th} transistor M14 is coupled between the first node N1 and the second power source VSS. Then, the gate electrode of the 14^{th} transistor M14 is coupled to the second node N2 via the 16^{th} capacitor C16. Therefore, the 16^{th} capacitor C16 is coupled between the gate electrode of the 14^{th} transistor M14 and the second node N2. The 14^{th} transistor M14 is turned on or off in accordance with the voltage applied to the second node N2.

The 15^{th} transistor M15 is coupled between the first power source VDD and the second node N2. Then, the gate electrode of the 15^{th} transistor M15 is coupled to a third input terminal 115 via the 15^{th} capacitor C15. Therefore, the 15^{th} capacitor C15 is coupled between the gate electrode of 15^{th} transistor M15 and the third input terminal 115. The 15^{th} transistor M15 is turned on or off in accordance with the voltage supplied to the third input terminal 115. Here, the third input terminal 115 receives a third clock signal CLK3 having a phase different from the phase of the first clock signal CLK1.

The 16^{th} transistor M16 is coupled between an output terminal 117 and the second power source VSS. Then, the gate electrode of the 16^{th} transistor M16 is coupled to the second node N2 via the 14^{th} capacitor c14. The 16^{th} transistor M16 is turned on or off in accordance with the voltage applied to the second node N2. On the other hand, the output terminal 117 is coupled to one of the scan lines S1 to Sn to output a scan signal.

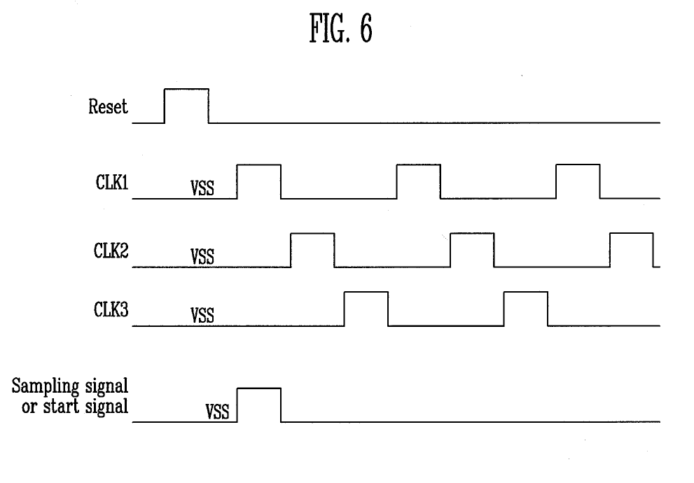

The 17^{th} transistor M17 is coupled between a second input terminal 114 and the output terminal 117. Then, the gate electrode of the 17^{th} transistor M17 is coupled to the first node N1 via the 13^{th} capacitor C13. The 17^{th} transistor M17 is turned on or off in accordance with the voltage applied to the first node N1. The second input terminal 114 receives a second clock signal CLK2 having a phase different from the phases of the first clock signal CLK1 and the third clock signal CLK3. For example, the clock signals CLK1 to CLK3 may be supplied in the order of the first clock signal CLK1, the second clock signal CLK2, and the third clock signal CLK3 as illustrated in FIG. 6. That is, the clocks signals CLK1 to CLK3 are sequentially supplied.

Additionally, the 18^{th} transistor M18 is formed between the gate electrode of the 17^{th} transistor M17 and the 16^{th} transistor M16 and the reset power source Vr. Then, the 19^{th} transistor M19 is formed between the gate electrodes of the 12^{th} transistor M12 to the 15^{th} transistor M15 and the reset power source Vr. In FIG. 5, the multiple instances of the 18^{th} transistor M18 may denote a single transistor or multiple transistors. Similarly, the multiple instances of the 19^{th} transistor M19 may denote a single transistor or multiple transistors. The 18^{th} transistor M18 and the 19^{th} transistor M19 are turned on when the reset signal (Reset) is supplied in order to supply the output of the reset power source Vr to the gate electrodes of the transistors M12 to M17.

On the other hand, in FIG. 5, the capacitors C13 to C18 are respectively coupled to the gate electrodes of the 12^{th} transistor M12 to the 17^{th} transistor M17.

However, the present invention is not limited to the above. In some embodiments, the 6^{th} and 17^{th} transistors are not often turned off by the movements of threshold voltages. Therefore, the 19^{th} transistor M19 and the 15^{th} to 18^{th} capacitors C15 to C18 may be omitted.

The 11^{th} capacitor C11 is coupled between the output terminal 117 and the first node N1. The 11^{th} capacitor C11 controls the voltage of the first node N1 to correspond to the voltage of the output terminal 117.

The 12^{th} capacitor C12 is coupled between the second node N2 and the second power source VSS. The 12^{th} capacitor C12 stores the voltage applied to the second node N2.

FIG. 6 is a waveform chart illustrating an embodiment of a method of driving the stage of FIG. 5.

Referring to FIG. 6, the reset signal (Reset) is supplied at the beginning of one frame before a stage is normally driven. In the period where the reset signal (Reset) is supplied, the first to third clock signals CLK1 to CLK3 are set to have low voltages (e.g., the voltage of the second power source VSS). Therefore, the voltage of the second power source VSS is supplied to the first input terminal 113, the second input terminal 114, and the third input terminal 115. In the period where the reset signal (Reset) is supplied, the voltage of the second power source VSS is supplied to the fourth input terminal 116. Therefore, the first electrode of the tenth transistor M10 or the 11^{th} transistor M11 may be additionally coupled to the fourth input terminal 116.

When the reset signal (Reset) is supplied, the tenth transistor M10, the 11^{th} transistor M11, the 18^{th} transistor M18, and the 19^{th} transistor M19 are turned on.

When the 10^{th} transistor M10 is turned on, the voltage of the second power source VSS is supplied to the first node N1. When the 11^{th} transistor M11 is turned on, the voltage of the second power source VSS is supplied to the second node N2. When the 18^{th} and 19^{th} transistors M18 and M19 are turned on, the voltage of the reset power source Vr is supplied to the gate electrodes of the 12^{th} transistor M12 to the 17^{th} transistor M17. Therefore, the voltage corresponding to the difference between the reset power source Vr and the second power source VSS is charged in the 13^{th} capacitor C13 to the 18^{th} capacitor C18.

The start signal (or the sampling signal) is supplied in synchronization with the first clock signal CLK1. When the first clock signal CLK1 is supplied, the 13^{th} transistor M13 is turned on. When the 13^{th} transistor M13 is turned on, the start signal supplied to the fourth input terminal 116 is supplied to the first node N1. When the start signal is supplied to the first node N1, the 17^{th} transistor M17 is turned on. When the 17^{th} transistor M17 is turned on, the second input terminal 114 and the output terminal 117 are electrically coupled to each other. At this time, since the second input terminal 114 is maintained at the voltage of the low voltage signal VSS, a scan signal is not supplied to the output terminal 117.

When the start signal is supplied, the 12^{th} transistor M12 is turned on. When the 12^{th} transistor M12 is turned on, the output of the second power source VSS is supplied to the second node N2. When the output of the second power source VSS is supplied to the second node N2, the 14^{th} transistor M14 and the 16^{th} transistor M16 are each maintained a turn-off state.

After the first clock signal CLK1, the second clock signal CLK2 is supplied. At this time, since the 17^{th} transistor M17 maintains a turn-on state, the second clock signal CLK2 is output to the output terminal 117. Here, the second clock signal CLK2, which is supplied to the output terminal 117, is supplied to a scan line as a scan signal.

On the other hand, when the second clock signal CLK2 is supplied to the output terminal 117, the voltage of the first node N1 increases by the 11^{th} capacitor C11. Therefore, the 17^{th} transistor M17 stably maintains a turn-on state.

Then, the third clock signal CLK3 is supplied. When the third clock signal CLK3 is supplied, the 15^{th} transistor M15 is turned on. When the 15^{th} transistor M15 is turned on, the voltage of the first power source VDD is supplied to the second node N2. When the first power source VDD is supplied to the second node N2, the 14^{th} transistor M14 and the 16^{th} transistor M16 are turned on.

When the 14^{th} transistor M14 is turned on, the output of the second power source VSS is supplied to the first node N1 so that the 17^{th} transistor M17 is turned off. When the 16^{th} transistor M16 is turned on, the output of the second power source VSS is output to the output terminal 117. When the 16^{th} transistor M16 is turned on, the second power source VSS is output to the output terminal 117. According to the embodiment of the present invention, the stage supplies the scan signal to the output terminal 117 while repeating the above processes when the sampling signal or the start signal is supplied.

Since the above-described stage according to the embodiment of the present invention is constructed using the inverter illustrated in FIG. 1, the transistors M12 to M17 may be stably turned off.

On the other hand, the structure of the stage according to an embodiment of the present invention is not limited to the circuit illustrated in FIG. 5. According to some embodiments of the present invention, the stage may be constructed by incorporating the inverter of FIG. 1 to various suitable circuits. For example, the stage may be constructed by adding a capacitor and a transistor for supplying the output of the reset power source Vr to each of the gate electrodes of the transistors included in a suitable stage circuit. In this case, the tenth transistor M10 and the 11^{th} transistor M11 for controlling the voltages of the first node N1 and the second node N2 may be added. Those skilled in the art may construct various types of stages using the inverter according to the present invention and the suitable stage circuit.

In the above described embodiments, the inverter is formed of the NMOS transistors. However, the present invention is not limited to the above. The inverter according to the present invention may be formed of PMOS transistors.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An inverter comprising:
a first transistor coupled between a first power source and an output terminal of the inverter, and comprising a gate electrode coupled to a first input terminal of the inverter;
a second transistor coupled between a second power source and the output terminal, and comprising a gate electrode coupled to a second input terminal of the inverter;
a first capacitor coupled between the gate electrode of the first transistor and the first input terminal;
a second capacitor coupled between the gate electrode of the second transistor and the second input terminal;
a third transistor coupled between the gate electrode of the first transistor and a reset power source; and
a fourth transistor coupled between the gate electrode of the second transistor and the reset power source.

2. The inverter as claimed in claim 1, wherein the third transistor and the fourth transistor are configured to be turned on when a reset signal is supplied to gate electrodes of the third transistor and the fourth transistor.

3. The inverter as claimed in claim 2, wherein the inverter is configured to allow the reset signal to be supplied at least once before the inverter is normally driven in a normal driving period.

4. The inverter as claimed in claim 3, wherein the first power source and the second power source are configured to alternately and respectively supply voltages to the first input terminal and the second input terminal in the normal driving period.

5. The inverter as claimed in claim 2, wherein the first power source is configured to output a voltage higher than that of the second power source.

6. The inverter as claimed in claim 5, wherein the reset power source is configured to output a voltage lower than that of the second power source.

7. The inverter as claimed in claim 5, wherein the second power source is configured to supply a voltage to the first input terminal and the second input terminal when the reset signal is supplied.

8. The inverter as claimed in claim 1, wherein the first to fourth transistors comprise NMOS transistors.

9. An organic light emitting display comprising:
a scan driver comprising stages coupled to scan lines, the scan driver being configured to supply scan signals to the scan lines;
a data driver for supplying data signals to data lines; and
pixels positioned at crossing regions of the scan lines and the data lines,
wherein each of the stages comprises the inverter as claimed in claim 1.

10. An organic light emitting display comprising:
a scan driver comprising stages coupled to scan lines, the scan driver being configured to supply scan signals to the scan lines;
a data driver for supplying data signals to data lines; and
pixels positioned at crossing regions of the scan lines and the data lines,
wherein a stage of the stages comprises:
a first transistor coupled between a first input terminal of the stage and an output terminal of the stage, and having a gate electrode coupled to a first node;
a first capacitor coupled between the gate electrode of the first transistor and the first node;
a second transistor coupled between the output terminal and a second power source, and having a gate electrode coupled to a second node;
a second capacitor coupled between the gate electrode of the second transistor and the second node;
a third transistor coupled between the first node and the second power source, the third transistor being configured to be turned on when a reset signal is supplied to a gate electrode of the third transistor;
a fourth transistor coupled between the second node and the second power source, the fourth transistor being configured to be turned on when the reset signal is supplied to a gate electrode of the fourth transistor; and
a fifth transistor coupled between a reset power source and the gate electrodes of the first and second transistors, the fifth transistor being configured to be turned on when the reset signal is supplied to a gate electrode of the fifth transistor.

11. The organic light emitting display as claimed in claim 10, wherein the reset power source is configured to output a voltage lower than the second power source.

12. The organic light emitting display as claimed in claim 10, wherein the organic light emitting display is configured to allow the reset signal to be supplied at the beginning of one frame.

13. The organic light emitting display as claimed in claim 10, further comprising:
a sixth transistor coupled between a first power source and the second node, and having a gate electrode coupled to a second input terminal of the stage;
a seventh transistor coupled between the first node and the second power source, and having a gate electrode coupled to the second node;
an eighth transistor coupled between the first node and a third input terminal of the stage, and having a gate electrode coupled to a fourth input terminal of the stage; and
a ninth transistor coupled between the second node and the second power source, and having a gate electrode coupled to the third input terminal.

14. The organic light emitting display as claimed in claim 13, further comprising:
a third capacitor coupled between the gate electrode of the sixth transistor and the second input terminal;
a fourth capacitor coupled between the gate electrode of the seventh transistor and the second node;
a fifth capacitor coupled between the gate electrode of the eighth transistor and the fourth input terminal;
a sixth capacitor coupled between the gate electrode of the ninth transistor and the third input terminal; and
a tenth transistor coupled between the reset power source and the gate electrodes of the sixth, seventh, eighth, and ninth transistors, the tenth transistor being configured to be turned on when the reset signal is supplied to a gate electrode of the tenth transistor.

15. The organic light emitting display as claimed in claim 13, wherein the first, second, and fourth terminals are configured to respectively receive clock signals having different phases.

16. The organic light emitting display as claimed in claim 13, wherein the third terminal is configured to receive a sampling signal or a start signal of a previous stage.

17. The organic light emitting display as claimed in claim 10, further comprising:
a fourth capacitor coupled between the first node and the output terminal; and
a fifth capacitor coupled between the second node and the second power source.
